(19) United States
(12) Patent Application Publication
(10) Pub. No.: US 2010/0070380 A1
(43) Pub. Date: Mar. 18, 2010

(54) ELECTRONIC COMMERCE SYSTEM AND RECORDING MEDIUM FOR STORING PROGRAM OF MOBILE TERMINALS USING PERSONAL AREA NETWORK

(75) Inventors: Ji-Hyung Park, Seoul (KR); Jae-Heon Jeong, Kangreungsi (KR)

Correspondence Address: LEXYOUME IP GROUP, LLC, 5180 PARKSTONE DRIVE, SUITE 175, CHANTILLY, VA, 20151, US

(73) Assignee: Korea Institute of Science and Technology, Seoul (KR)

(21) Appl. No.: 12/516,221

(22) PCT Filed: Nov. 29, 2006
(86) PCT No.: PCT/KR06/05086

§ 371 Date: May 26, 2009

(51) Int. Cl. G06Q 30/00

(52) U.S. Cl. 705/26

(57) ABSTRACT

Disclosed are a mobile shopping agent and a shop agent seller for reducing negotiation burdens between a seller and a buyer. The mobile shopping agent detects the shop agent's entrance to a radio access area of a personal area network (Bluetooth, ultra wide-band, and Zigbee), requests shop goods information of desired goods from the shop agent through the radio access area of the personal area network when the shop agent has entered the radio access area, and receives the shop goods information. The mobile shopping agent requests online goods information on the desired goods from a goods information server through a communication network, and receives the online goods information. The mobile shopping agent determines a buying condition of the desired goods based on the shop goods information and the online goods information, and negotiates with the shop agent by using a game theory.

### TECHNICAL FIELD

The present invention relates to an electronic commerce device and a recording medium for storing a program for performing electronic commerce. Particularly, the present invention relates to an electronic commerce device for reducing a negotiation burden between a seller and a buyer.

### BACKGROUND ART

In general, a user searches information from a price-providing web site to make a purchase on the Internet, or he buys desired goods from an offline shop. In the former case, the user can find cheap goods, but he cannot actually check them. In the latter case, he must visit the shop that sells the corresponding goods, ask for goods information, and negotiate for the goods.

Recently, the mobile Internet (Wi-Bro, HSPDA, WLAN, HPi, Wi-Fi, and EV-DO) and the personal area networks (Bluetooth, ultra wide-band, and Zigbee) have been greatly developed. As application cases of using the above-noted network techniques, a Korean application (No. 10-2003-0067243) entitled “Advertising System and Method for a Vehicle using Mobile Internet and Bluetooth,” a Korean application (No. 10-2000-0083145) entitled “Advertisement Service Providing System and Method using Bluetooth Terminal, and Advertisement Service Receiving Method by a Bluetooth Terminal,” a Korean application (No. 10-2000-0078196) entitled “Wireless Advertisement System and Method,” a Korean application (No. 10-2002-0019525) entitled “Performance Display Information Providing System and Method using Bluetooth Function,” and a Korean application (No. 10-2002-0027118) entitled “Online Advertising Method using Portable Digital Device installing Bluetooth” have been proposed. Also, a Korean application (No. 10-2004-0026554) entitled “Make Friends Service Providing Method of Mobile Terminal using Bluetooth,” a Korean application (No. 10-2000-0067698) entitled “Ideal Type Searching Device and Method using Bluetooth,” and a Korean application (No. 10-2000-0052238) entitled “Automatic Visitor Guide Service Providing Method and System using Portable Terminal Device and Bluetooth Skill” have been proposed. Since a shop master broadcasts an advertisement to a user in the advertisement service, the user receives unneeded information and undesired transmission traffic occurs.

Further, a Korean application (No. 10-2000-002336) entitled “Mediation Optimization and Automatic Negotiation Electronic Commerce System and Method by a Multi-agent that is a System for Mediating and Negotiating a Plurality of Buyers and a Plurality of Sellers, and a Buyer and a Seller on the Web” has been proposed. However, the system cannot actively process the users' movement since there is a plurality of buyers and sellers access the web server, and it has to open the accounting problems of the goods.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide an electronic commerce system and service providing method by a mobile terminal using a personal area network for reducing a negotiation burden between a seller and a buyer.

In one aspect of the present invention, an electronic commerce system includes: a desired goods storage module for registering a user's desired goods; a first communication module for detecting a shop agent's entrance to a radio access area of a personal area network, requesting shop goods information of the desired goods from the shop agent through the radio access area of the personal area network, and receiving the shop goods information of the desired goods when the shop agent has entered the radio access area; a second communication module for requesting online goods information on the desired goods from the goods information server through a communication network, and receiving the same; a buying negotiation module for determining a buying condition of the desired goods based on the shop goods information and the online goods information, providing the determined buying condition to the shop agent through the radio access area of the personal area network, and performing negotiation on the buying of the desired goods with the shop agent; and a user interface module for notifying the user of a negotiated buying condition when the negotiation is successful.

The electronic commerce system can further include a buying strategy storage module for registering a buying strategy on the desired goods, and the buying negotiation module can determine the buying condition in consideration of the buying strategy.

### Technical Solution

In another aspect of the present invention, an electronic commerce system includes: a shop goods information storage module for registering shop goods information that is information on the goods stocked in a shop; a first communication module for receiving a request for information on the desired goods from a mobile shopping agent that forms a radio access area of a personal area network and has entered the radio access area of the personal area network; a query module for querying to the shop goods information storage module to provide shop goods information on the desired goods to the mobile shopping agent through the first communication module when information on the desired goods is registered to the shop goods information storage module; a sales negotiation module for receiving a buying condition from the mobile shopping agent through the first communication module, negotiating with the mobile shopping agent about buying of the desired goods, and determining sales of the desired goods; and a user interface module for notifying the user of the negotiated buying condition when the negotiation is successful.

In another aspect of the present invention, a recording medium for storing a program includes functions of: requesting shop goods information of desired goods from the shop agent through a radio access area of the personal area network when the shop agent has entered the radio access area of the personal area network, and receiving the shop goods information; requesting online goods information of the desired goods from a goods information server through a communication network, and receiving the online goods information; determining a buying condition of the desired goods based on the shop goods information and the online goods information; providing the determined buying condition to the shop agent through the radio access area of the personal area network, and negotiating with the shop agent regarding buying of the desired goods; and notifying the negotiated buying condition of the user when the negotiation is successful.

In another aspect of the present invention, a recording medium for storing a program includes functions of: forming a radio access area of a personal area network; providing shop goods information on the desired goods to the mobile shopping agent through the radio access area of the personal area network when receiving a request information on the desired goods from a mobile shopping agent having entered the radio access area of the personal area network; receiving a buying condition from the mobile shopping agent through the radio access area of the personal area network; determining the sales for the desired goods by negotiating with the mobile shopping agent regarding buying of the desired goods according to the buying condition; and notifying the user of the negotiated buying condition when the negotiation is successful.

### DESCRIPTION OF DRAWINGS

FIG. 1 is an electronic commerce system according to an exemplary embodiment of the present invention.

FIG. 2 is a block diagram for the shop agent according to an exemplary embodiment of the present invention.

FIG. 3 is a block diagram for the mobile shopping agent according to an exemplary embodiment of the present invention.

FIG. 4 is a block diagram for the online goods information server according to an exemplary embodiment of the present invention.

FIG. 5 shows an electronic commerce method according to an exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

Also, the term “module” in the present specification represents a unit for processing a predetermined function or operation, which can be realized by hardware, software, or a combination of hardware and software.

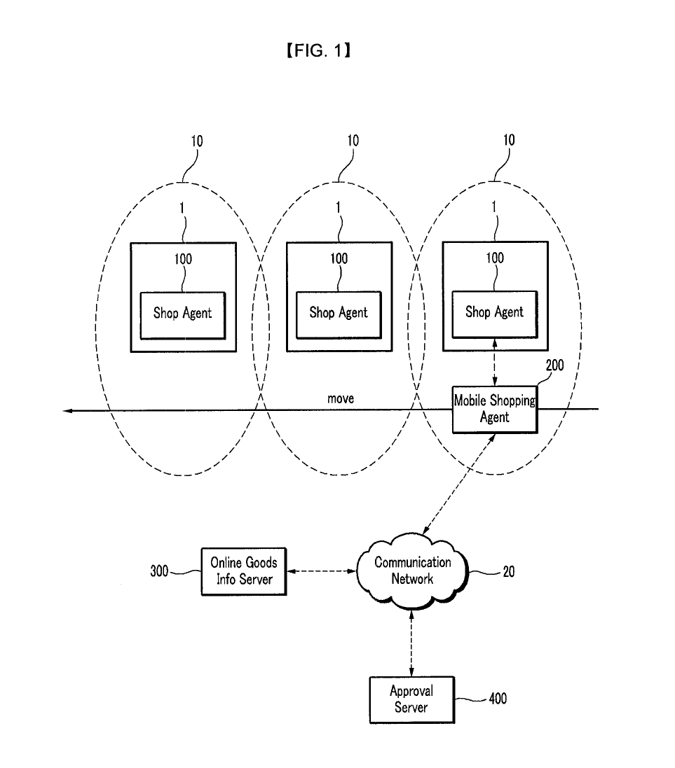

Referring to FIG. 1, an electronic commerce system according to an exemplary embodiment of the present invention will now be described. The Bluetooth network, which is one of the personal area networks, will be exemplified in the exemplary embodiment of the present invention.

FIG. 1 is an electronic commerce system according to an exemplary embodiment of the present invention.

As shown in FIG. 1, the electronic commerce system includes a mobile shopping agent 200, a shop agent 100, an online goods information server 300, and an approval server 400.

The shop agent 100 is installed in the shop 1 and forms a Bluetooth radio access area 10. The shop agent 100 is installed as a program in a personal computer or is realized as a dedicated terminal.

The Bluetooth is used for the radio access method in the exemplary embodiment, and other radio access methods including the ultra wide-band and the Zigbee can be used for the personal area network. The radio access area when the Bluetooth is used as the radio access method corresponds to the piconet.

The mobile shopping agent 200 is realized as a mobile terminal, and is connected to the Bluetooth radio access area 10 and the communication network 20. The communication network 20 uses the portable Internet (WiBro and wireless Broadband), high speed downlink packet access (HSDPA), the wireless local area network (WLAN), the wireless fidelity (Wi-Fi), and the evolution data only (EV-DO).

The online goods information server 300 is connected to the communication network 20 and provides goods information to the mobile shopping agent 200.

The approval server 400 is connected to the communication network 20 and provides an online approval service to the mobile shopping agent 200.

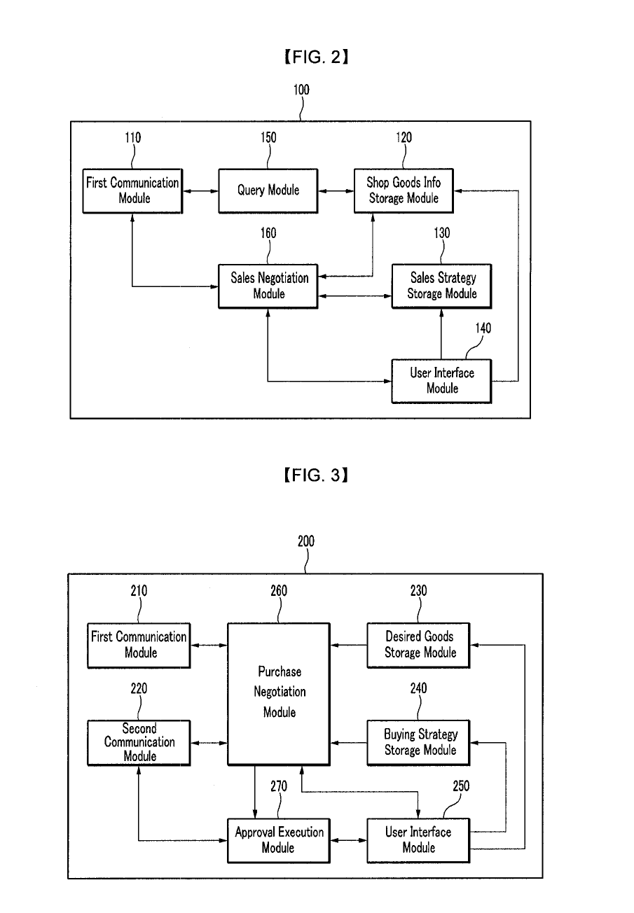

Referring to FIG. 2, the shop agent 100 according to an exemplary embodiment of the present invention will now be described.

FIG. 2 is a block diagram for the shop agent 100 according to the exemplary embodiment of the present invention.

As shown in FIG. 2, the shop agent 100 includes a first communication module 110, a shop goods information storage module 120, a sales strategy storage module 130, a user interface module 140, a query module 150, and a sales negotiation module 160.

The first communication module 110 communicates with the mobile shopping agent 200 through the Bluetooth radio access area 10.

The shop goods information storage module 120 stores shop goods information that is information on the goods stocked in the shop 1.

The sales strategy storage module 130 stores a sales strategy on the goods stocked in the shop 1.

The user interface module 140 receives goods information and sales strategy from the user and registers them to the shop goods information storage module 120 and the sales strategy storage module 130.

The query module 150 queries to the shop goods information storage module 120 and provides shop goods information to the mobile shopping agent 200 through the first communication module 110.

The sales negotiation module 160 negotiates with the mobile shopping agent 200 about the goods sales through the first communication module 110.

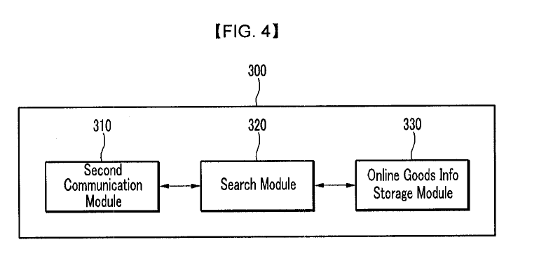

Referring to FIG. 3, the mobile shopping agent 200 according to the exemplary embodiment of the present invention will now be described.

FIG. 3 is a block diagram for the mobile shopping agent 200 according to the exemplary embodiment of the present invention.

As shown in FIG. 3, the mobile shopping agent 200 includes a first communication module 210, a second communication module 220, a desired goods storage module 230, a buying strategy storage module 240, a user interface module 250, a buying negotiation module 260, and a approval execution module 270.

The first communication module 210 forms the Bluetooth radio access area 10 and communicates with the shop agent 100 through the Bluetooth radio access area 10.

The second communication module 220 communicates with the online goods information server 300 and the approval server 400 through the communication network 20.

The desired goods storage module 230 stores desired goods of the user of the mobile shopping agent 200 as a goods code.

The buying strategy storage module 240 stores the buying strategy on the user's desired goods.

The user interface module 250 receives desired goods and buying strategy from the user and registers them to the desired goods storage module 230 and the buying strategy storage module 240.

The buying negotiation module 260 negotiates with the shop agent 100 about buying of desired goods through the first communication module 210.

The approval execution module 270 performs an online approval with the approval server 400 through the second communication module 220 when the negotiation on the buying of desired goods is successful.

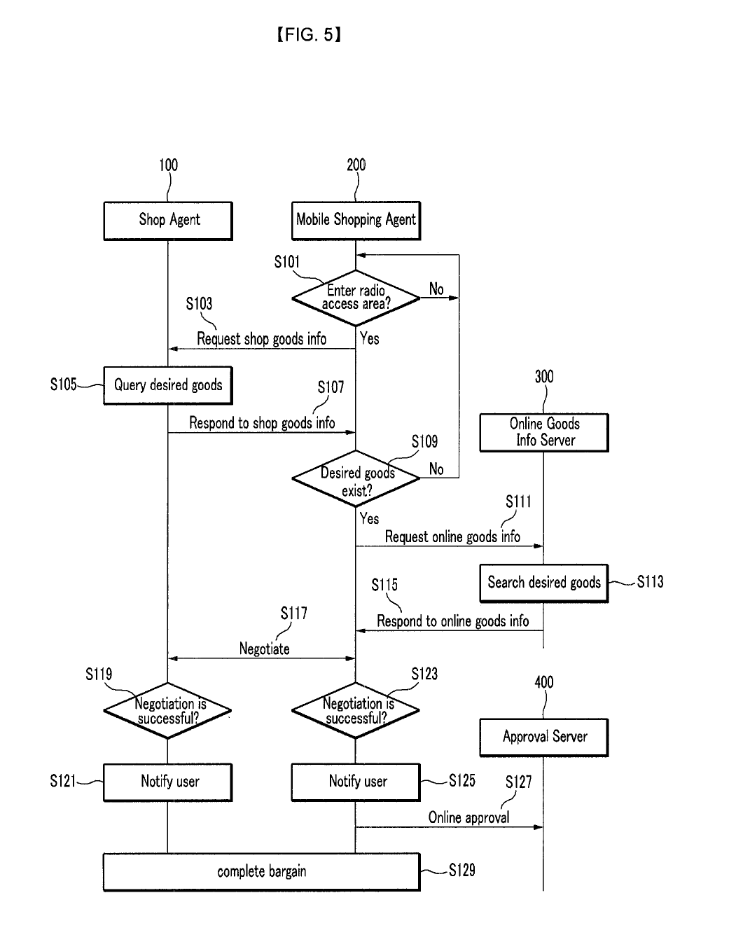

Referring to FIG. 4, the online goods information server 300 according to the exemplary embodiment of the present invention will now be described.

FIG. 4 is a block diagram for the online goods information server 300 according to the exemplary embodiment of the present invention.

As shown in FIG. 4, the online goods information server 300 includes a second communication module 310, a search module 320, and an online goods information storage module 330.

The second communication module 310 communicates with the mobile shopping agent 200 through the communication network 20.

The search module 320 searches the online goods information storage module 330 and provides searched online goods information to the mobile shopping agent 200 through the second communication module 310.

The online goods information storage module 330 stores online goods information.

Referring to FIG. 5, an electronic commerce method according to an exemplary embodiment of the present invention will be described.

FIG. 5 shows an electronic commerce method according to an exemplary embodiment of the present invention.

As shown in FIG. 5, the first communication module 210 of the mobile shopping agent 200 determines whether the mobile shopping agent 200 has entered the Bluetooth radio access area 10 (S101).

When the mobile shopping agent 200 has entered the Bluetooth radio access area 10, the buying negotiation module 260 of the mobile shopping agent 200 determines whether the user's desired goods are registered to the desired goods storage module 230, and requests shop goods information on the corresponding goods from the shop agent 100 through the first communication module 210 when the goods are registered thereto (S103). In this instance, when the desired goods storage module 230 stores a plurality of desired goods, the buying negotiation module 260 can request shop goods information on a plurality of desired goods from the shop agent 100 through the first communication module 210.

On receiving the request for the shop goods information on the desired goods through the Bluetooth radio access area 10, the first communication module 110 transmits the request to the query module 150, and the query module 150 queries to the shop goods information storage module 120 to determine whether the desired goods requested by the mobile shopping agent 200 are registered (S105). When the desired goods requested by the mobile shopping agent 200 are provided in the shop goods information storage module 120, the query module 150 provides shop goods information on the corresponding desired goods to the mobile shopping agent 200 through the first communication module 110 (S107). However, when the desired goods requested by the mobile shopping agent 200 are not provided in the shop goods information storage module 120, the query module 150 provides information that the shop 1 does not have the desired goods to the mobile shopping agent 200 through the first communication module 110 (S107). Accordingly, the user of the mobile shopping agent 200 can quickly and easily check whether the desired goods are stored in the shop 1 without entering the shop 1.

On receiving shop goods information on the desired goods, the buying negotiation module 260 of the mobile shopping agent 200 can check whether the shop 1 stores the desired goods (S109), and requests online goods information from the online goods information server 300 through the second communication module 220 after having received the shop goods information (S111).

On receiving the request for the online goods information on the desired goods through the communication network 20 and the second communication module 310, the search module 320 of the online goods information server 300 searches the online goods information storage module 330 (S113). The search module 320 provides the searched online goods information to the mobile shopping agent 200 through the second communication module 310 (S115). In this instance, the online goods information includes the desired goods' online lowest price, online highest price, delivery method, approval method, color, brand, buying quantity, coupon, points, mileage, and reserve.

On receiving shop goods information and online goods information on the desired goods, the buying negotiation module 260 negotiates with the sales negotiation module 160 of the shop agent 100 (S117). In this instance, the buying negotiation module 260 and the sales negotiation module 160 can negotiate with each other by using the game theory. In detail, the buying negotiation module 260 determines a buying condition based on the shop goods information and the online goods information on the desired goods and the buying strategy registered to the buying strategy storage module 240, and proposes the buying condition to the sales negotiation module 160. The sales negotiation module 160 can accept or reject the buying condition proposed by the buying negotiation module 260 according to the sales strategy registered to the sales strategy storage module 130, or can propose a new condition to the buying negotiation module 260. Here, the buying strategy and the sales strategy includes changes of negotiation items including price, delivery method, approval method, color, brand, buying quantity, coupon, points, mileage, and reserve.

For example, the buying negotiation module 260 determines the buying negotiation proposal that satisfies the buying strategy. The buying negotiation module 260 can estimate the user's selection on the negotiation items including price, delivery, approval method, color, brand, buying quantity, coupon, points, mileage, and reserve included by the buying negotiation proposal. The estimation method is as follows. First, the user sets the prices for the respective items. Weights are assigned to the items depending on the user's priorities. The buying negotiation module 260 divides each weight by a value of the sum of all weights and multiplies the price of each item by the divided value. The sum of the calculated items will be called the value of the buying negotiation proposal. In this instance, the buying negotiation module 260 substitutes a discount factor of the mobile shopping agent 200, a discount factor of the shop agent 100, and the value of the buying negotiation proposal estimated by the buying negotiation module 260 into the negotiation equation of the game theory. The buying negotiation module 260 determines a value to be accepted and a value to be proposed through the negotiation equation. The buying negotiation module 260 estimates the value of the shop negotiation proposal provided by the shop agent 100, accepts the shop negotiation proposal when the value of the shop negotiation proposal is greater than the value to be accepted, and notifies the shop agent 100 of negotiation success. Otherwise, when the value of the shop negotiation proposal is less than the value to be accepted, the buying negotiation module 260 changes the negotiation items of the shop negotiation proposal to generate a new negotiation proposal, and provides the new negotiation proposal to the shop agent 100. The buying negotiation module 260 repeats the negotiation proposal control process a predetermined number of times, and notifies the shop agent 100 of negotiation breakdown when the negotiation is not successful.

The sales negotiation module 160 determines a sales negotiation proposal for satisfying the sales strategy. The sales negotiation module 160 can estimate the user's selection on the negotiation items including price, delivery, approval method, color, brand, buying quantity, coupon, points, mileage, and reserve included by the sales negotiation proposal. The estimation method is as follows. First, the user sets the prices for the respective items. Weights are assigned to the items depending on the user's priorities. The sales negotiation module 160 divides each weight by a value of the sum of all weights and multiplies the price of each item by the divided value. The sum of the calculated items will be called the value of the sales negotiation proposal. In this instance, the sales negotiation module 160 substitutes a discount factor of the mobile shopping agent 200, a discount factor of the shop agent 100, and the value of the sales negotiation proposal into a negotiation equation of the game theory. The sales negotiation module 160 determines a value to be accepted and a value to be proposed through the negotiation equation. The sales negotiation module 260 estimates the value of the user negotiation proposal provided by the mobile shopping agent 200, accepts the user negotiation proposal when the value of the user negotiation proposal is greater than the value to be accepted, and notifies the mobile shopping agent 200 of negotiation success. Otherwise, when the value of the shop negotiation proposal is less than the value to be accepted, the sales negotiation module 160 changes the negotiation items of the user negotiation proposal to generate a new negotiation proposal, and provides the new negotiation proposal to the mobile shopping agent 200. The sales negotiation module 160 repeats the negotiation proposal control process a predetermined number of times, and notifies the mobile shopping agent 200 of negotiation breakdown when the negotiation is not successful.

The buying strategy may include a negotiation item condition change. The negotiation item condition change is information for providing a different condition to the next negotiation when the condition is not satisfied in the current negotiation. For example, when the buying strategy is set to increase the acceptance price by 5% and the sales negotiation module 160 does not accept the buying price proposed by the buying negotiation module 260, the negotiation is immediately broken down, and hence the sales negotiation module 160 accepts or rejects the price by determining the value of the buying price according to the sales strategy registered to the sales strategy storage module 130. That is, the sales negotiation module 160 estimates the value of the condition of the negotiation item, notifies the buying negotiation module 260 of negotiation success when the buying proposal value is greater than the sales acceptance value, and notifies the buying negotiation module 260 of negotiation breakdown when the buying proposal value is less than the sales acceptance value.

When the sales negotiation on the desired goods is successful (S119), the sales negotiation module 160 notifies the user of the shop agent 100 of the success through the user interface module 140 (S121).

When the buying negotiation on the desired goods is successful (S123), the buying negotiation module 260 notifies the user of the mobile shopping agent 200 of the success through the user interface module 250 (S125).

The user is set to settle the goods according to the determination by the agent, or is set to buy the same after the buyer's checking. When the user is set to buy the goods after the buyer's checking, the approval execution module 270 receives buying determination information from the user through the user interface module 250 and performs an online approval with the approval server 400 through the second communication module 220 (S127). When the user is set to settle the goods according to the determination by the agent, the approval execution module 270 performs an online approval with the approval server 400 through the second communication module 220 without the buying determination information from the user.

The shop agent 100 and the mobile shopping agent 200 negotiate with each other, and the user of the mobile shopping agent 200 receives the desired goods to thus complete the bargain (S129).

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

According to the exemplary embodiment of the present invention, since the mobile shopping agent can search goods stored in the shop from the shop agent by communicating with the shop agent through the radio access area of the personal area network, the user of the mobile shopping agent can quickly and easily know the stock status of the desired goods in the shop without visiting the shop.

Also, according to the exemplary embodiment of the present invention, since the mobile shopping agent collects shop goods information and online goods information to determine the prices and negotiates with the shop agent regarding the goods purchase, the seller and the buyer have no negotiation burden.

Further, since the mobile shopping agent and the shop agent search the goods, determine the prices, and perform negotiation, the buyer can easily search the shops that sell the desired goods when there is a plurality of desired goods, and can quickly perform negotiation, so the shopping time can be reduced and reasonable transactions can be performed.

1. An electronic commerce system comprising:
a desired goods storage module for registering a user's desired goods;
a first communication module for detecting a shop agent's entrance to a radio access area of a personal area network, requesting shop goods information of the desired goods from the shop agent through the radio access area of the personal area network, and receiving the shop goods information of the desired goods when the shop agent has entered the radio access area;
a second communication module for requesting online goods information on the desired goods from the goods information server through a communication network, and receiving the same;
a buying negotiation module for determining a buying condition of the desired goods based on the shop goods information and the online goods information, providing the determined buying condition to the shop agent through the radio access area of the personal area network, and performing negotiation on the buying of the desired goods with the shop agent; and
a user interface module for notifying the user of a negotiated buying condition when the negotiation is successful.

2. The electronic commerce system of claim 1, wherein the electronic commerce system further includes a buying strategy storage module for registering a buying strategy on the desired goods, and
the buying negotiation module determines the buying condition in consideration of the buying strategy.

3. The electronic commerce system of claim 2, wherein
the buying strategy includes a change of the negotiation item.

4. The electronic commerce system of claim 3, wherein
the negotiation item includes at least one of price, delivery method, approval method, color, brand, buying quantity, coupon, points, mileage, and reserve.

5. The electronic commerce system of claim 4, wherein
the online goods information includes at least one of lowest price, the desired goods, highest price, delivery method, approval method, color, brand, buying quantity, coupon, points, mileage, and reserve of the desired goods.

6. The electronic commerce system of claim 5, wherein
the buying negotiation module determines a first negotiation proposal for satisfying the buying strategy based on the online goods information, and provides a second negotiation to the shop agent when the value of the first negotiation proposal is less than the value of the second negotiation proposal according to the shop goods information.

7. The electronic commerce system of claim 6, wherein
when the value of the first negotiation proposal is greater than the value of the second negotiation proposal, the buying negotiation module changes a value of a negotiation item of the second negotiation proposal to determine a third negotiation proposal, and provides the third negotiation proposal to the shop agent.

8. The electronic commerce system of claim 7, wherein
the buying negotiation module repeats control of the negotiation proposal a predetermined number of times, and notifies the shop agent of negotiation breakdown when the negotiation is not successful within the predetermined number of times.

9. The electronic commerce system of claim 1, further comprising
a approval execution module for performing an online approval with a approval server through the communication network when receiving buying determination information from the user.

10. A recording medium for storing a program including functions of:
detecting an entrance of a shop agent to a radio access area of a personal area network;
requesting shop goods information of desired goods from the shop agent through a radio access area of the personal area network when the shop agent has entered the radio access area of the personal area network to receive the shop goods information;
requesting online goods information of the desired goods from a goods information server through a communication network to receives the online goods information;
determining a buying condition of the desired goods based on the shop goods information and the online goods information;
providing the determined buying condition to the shop agent through the radio access area of the personal area network to negotiate with the shop agent about buying of the desired goods; and
notifying the negotiated buying condition of the user when the negotiation is successful.

11. The recording medium of claim 10, wherein
the buying strategy includes a change of negotiation items including at least one of price, delivery method, approval method, color, brand, buying quantity, coupon, points, mileage, and reserve, and
the online goods information includes at least one of lowest price, highest price, delivery method, approval method, color, brand, buying quantity, coupon, points, mileage, and reserve of the desired goods.

12. The recording medium of claim 11, wherein
the negotiating of buying of the desired goods includes functions of:
determining a first negotiation proposal for satisfying the buying strategy based on the online goods information;
calculating a value to be accepted by using a value of the first negotiation proposal and discount factor information of a game theory caused by the user;
estimating a value of a second negotiation proposal according to the shop goods information; and
accepting the second negotiation proposal and notifying the shop agent of negotiation success when the value of the second negotiation proposal is greater than the value to be accepted.

13. An electronic commerce system comprising:
a shop goods information storage module for registering shop goods information that is information on the goods stocked in a shop;
a first communication module for receiving a request of information on the desired goods from a mobile shopping agent that forms a radio access area of a personal area network and has entered the radio access area of the personal area network;
a query module for querying to the shop goods information storage module to provide shop goods information on the desired goods to the mobile shopping agent through the first communication module when information on the desired goods is registered to the shop goods information storage module;
a sales negotiation module for receiving a buying condition from the mobile shopping agent through the first communication module, negotiating with the mobile shopping agent about buying of the desired goods to determine sales of the desired goods; and
a user interface module for notifying the user of the negotiated buying condition when the negotiation is successful.

14. The electronic commerce system of claim of claim 13, wherein the electronic commerce system further includes a sales strategy storage module for registering a sales strategy for the goods stocked in the shop, and
the sales negotiation module determines sales for the desired goods in consideration of the buying condition and the sales strategy.

15. The electronic commerce system of claim of claim 14, wherein
the buying condition includes at least one of price, delivery method, approval method, color, brand, buying quantity, coupon, points, mileage, and reserve, and
the sales strategy includes a change of a negotiation items including at least one of price, delivery method, approval method, color, brand, buying quantity, coupon, points, mileage, and reserve.

16. The electronic commerce system of claim 15, wherein
the sales negotiation module determines a first negotiation proposal for satisfying a sales strategy to provide a second negotiation proposal to the mobile shopping agent when a value of the first negotiation proposal is less than a value of the second negotiation proposal of the mobile shopping agent.

17. The electronic commerce system of claim 16, wherein
the sales negotiation module changes a value of the negotiation items to generate a third negotiation proposal when the value of the first negotiation proposal is greater than the value of the second negotiation proposal of the mobile shopping agent to provide the third negotiation proposal to the mobile shopping agent.

18. The electronic commerce system of claim 16, wherein
the sales negotiation module repeats control of the negotiation proposal a predetermined number of times, and notifies the mobile shopping agent of negotiation breakdown when the negotiation is not successful.

19. The electronic commerce system of claim 15, wherein
the sales negotiation module determines a first negotiation proposal of a shop agent for satisfying the sales strategy, calculates a value to be accepted by using the value of the first negotiation proposal and discount factor information of a game theory caused by the user, accepts a second negotiation proposal when the value of the second negotiation proposal provided by the mobile shopping agent is greater than the value to be accepted, and notifies the mobile shopping agent of negotiation success.

20. A recording medium for storing a program including functions of:
forming a radio access area of a personal area network;
providing shop goods information on desired goods to a mobile shopping agent through the radio access area of the personal area network when receiving a request for information on the desired goods from a mobile shopping agent having entered the radio access area of the personal area network;
receiving a buying condition from the mobile shopping agent through the radio access area of the personal area network;
determining sales for the desired goods by negotiating with the mobile shopping agent about buying the desired goods according to the buying condition; and
notifying the user of the negotiated buying condition when the negotiation is successful.

21. The recording medium of claim 20, wherein
the determining of the sales for the desired goods includes
determining the sales for the desired goods in consideration of the buying condition and a sales strategy.
